(19) United States
(12) Patent Application Publication
(10) Pub. No.: US 2014/0298188 A1
(43) Pub. Date: Oct. 2, 2014

(54) REMOTE OPERATION METHOD AND SYSTEM

(71) Applicant: TENCENT TECHNOLOGY (SHENZHEN) COMPANY LIMITED, Shenzhen City (CN)

(72) Inventors: Hang DONG, Shenzhen City (CN); Kui HUANG, Shenzhen City (CN); Xuan LUO, Shenzhen City (CN); Xinqiu XIE, Shenzhen City (CN)

(21) Appl. No.: 14/301,261

(22) Filed: Jun. 10, 2014

Related U.S. Application Data
(63) Continuation of application No. PCT/CN2013/089749, filed on Dec. 18, 2013.

(30) Foreign Application Priority Data
Mar. 8, 2013 (CN) 201310075923.9

(51) Int. Cl. H04L 29/08

(52) U.S. Cl. CPC H04L 67/025
USPC 715/740

(57) ABSTRACT

A remote operation method includes the following steps: receiving a remote operation request; returning a webpage interface for remote operation according to the remote operation request; receiving an operation instruction sent via the webpage interface; responding to the operation instruction and returning information corresponding to the operation instruction. A remote operation system is also disclosed. The above-mentioned method and system transmit the operation instruction through the webpage interface without need of real-time transmission of the computer operation screen, which can save the amount of the data to be transferred, so the demand for network bandwidth and the data processing amount by the control terminal and controlled terminal are both reduced.

### CROSS REFERENCE TO RELATED APPLICATIONS

This application is a continuation application of the PCT International Application No. PCT/CN2013/089749, filed on Dec. 18, 2013, entitled “REMOTE OPERATION METHOD AND SYSTEM” by Hang DONG, Kui HUANG, Xuan LUO and Xinqiu XIE, which claims the priority from the Chinese patent application No. CN 201310075923.9, filed on Mar. 8, 2013. The above-referenced applications are hereby incorporated herein in their entireties by reference.

### FIELD OF THE INVENTION

The disclosure relates generally to the field of information technology, and more particularly, to a remote operation method and system.

### BACKGROUND OF THE INVENTION

A remote desktop can allow a user at a computer to see the current desktop picture of a computer at the other end of the network, and enable the user to control and operate the mouse, the keyboard of the computer at the other end of the network. That is, when a terminal A runs a remote operate software, the terminal A can be controlled by using a terminal B at the other end of the network. Generally, the terminal A is a computer, the terminal B can be a PC, a mobile phone or a tablet PC, and the terminal A and the terminal B both need to install relevant remote operation software.

The realization principle of the remote desktop is mainly to establish a Socket connection between the controlled terminal and the control terminal. The controlled terminal captures the desktop data of its host regularly and transfers the data to the control terminal. All the actions of the control terminal conducted on the analog screen, including mouse actions and keyboard actions, are sent to the controlled terminal as respective information. The controlled terminal performs respective mouse events and keyboard events according to the information.

For a traditional remote desktop, the control and controlled terminals both need to install relevant software, and need to transmit the computer operation screen and the data of the control device, e.g. a mouse, a keyboard, etc., in real time, therefore, the data amount is relatively large, and the required network bandwidth is high. Hence, the remote desktop is a relatively “heavy” scheme for remotely accessing and operating a computer, and can meet the requirements of some users who need to see the desktop of the controlled computer in real time.

### SUMMARY OF THE INVENTION

Based on the above, it is necessary to provide a remote operation method and system aiming at the problem that the data amount is relatively large when a traditional remote desktop is transmitting the computer operation screen in real time.

According to one aspect of the disclosure, a remote operation method includes the following steps:

receiving a remote operation request;

returning a webpage interface for remote operation according to the remote operation request;

receiving an operation instruction sent via the webpage interface; and

responding to the operation instruction and returning information corresponding to the operation instruction.

According to another further aspect of the disclosure, a remote operation system includes:

a request receiving module, configured to receive a remote operation request;

a webpage interface module, configured to return a webpage interface for remote operation according to the remote operation request;

an operation receiving module, configured to receive an operation instruction sent via the webpage interface; and

an information returning module, configured to respond to the operation instruction and return information corresponding to the operation instruction.

The above-mentioned method and system transmit the operation instruction through the webpage interface without need of real-time transmission of the computer operation screen; the information amount of the webpage interface is controllable, for example, when accessing the file information in the current directory at the controlled terminal, only the text directory information of the file information needs to be transmitted, and when transmitting control instructions, such as shutdown, lock screen, etc., only these instructions per se need to be transmitted, therefore, the data amount that need to be transmitted can be saved, which reduces not only the demand for network bandwidth but also the data processing amount by the control and controlled terminals. Moreover, since the control terminal only requires a browser or other tools capable of accessing webpage in order to perform an operation, which can be realized without need of installing specific software at the control terminal, while the browser and webpage accessing tools are almost equipped in each computer and each mobile phone, therefore, user convenience is improved.

### BRIEF DESCRIPTION OF DRAWINGS

FIG. 1 is a flowchart illustrating a remote operation method according to an embodiment of the present disclosure.

FIG. 2 is a schematic diagram illustrating the initial state of a webpage interface for remote operation according to an embodiment of the present disclosure.

FIG. 3 is a schematic diagram illustrating the state of a webpage interface for remote operation after operated by a user according to an embodiment of the present disclosure.

FIG. 4 is a schematic diagram illustrating the state of a webpage interface for remote operation when embedded playing is not supported by the webpage interface according to an embodiment of the present disclosure.

FIG. 5 is a detailed flowchart illustrating the steps of responding to an operation instruction and returning information corresponding to the operation instruction according to an embodiment of the present disclosure.

FIG. 6 is a schematic diagram illustrating a webpage interface for remote operation when the webpage interface is performing a control instruction according to an embodiment of the present disclosure.

FIG. 7 is a module diagram illustrating a remote operation system according to an embodiment of the present disclosure.

FIG. 8 is schematic diagram illustrating an information returning module according to an embodiment of the present disclosure.

### DETAILED DESCRIPTION OF THE INVENTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

With the development of mobile terminal devices, more and more people start to use mobile terminal devices, such as mobile phone, tablet PC, etc., to do entertainment, work, study. However, at the current stage, the storing and computing capacities of the mobile devices are limited, and most people store resources, e.g. video, audio, pictures, office/learning resources, on desktop or laptop computers, so, there is a demand for obtaining or accessing file resources on a desktop or laptop computer from a mobile terminal device, or even controlling the desktop or laptop computer, for example, controlling the shutdown of the desktop or laptop computer by using a mobile phone, simulating the mouse, keyboard operations of the desktop or laptop computer, using the mobile phone as a remote control device, etc. The term “access” in the present technical solution refers to read file directory name or file name, delete, copy, paste, rename file or file directory, read file content, search, etc., that is, the specific form of the “ access ” can be expanded according to need, similarly to the operation of resource manager in the Windows operating system.

The present technical solution can adopt a controlled terminal, such as a desktop or laptop computer, as a server of World Wide Web (Web), and then access file resources in the controlled terminal via browsers of various terminal devices (e.g. iOS, Android, Windows Phone, Symbian, PC, etc.) at the other end of the network. For instance, a mobile phone or tablet PC is used to watch or download videos, music, pictures in the controlled terminal, and at the same time, the mobile phone or tablet PC can browse files with formats of PDF, PPT, Excel, Word, TXT, etc. It is convenient for the users that, the control terminal is not necessary to be installed specific software and can only use its own browser to do the accessing. In addition, the control terminal can not only browse file resources in the user's computer, but also upload files (videos, pictures, documents, programs, etc.) of the controlled terminal, and control the computer, for example, lock the computer, shutdown, adjust the volume.

For easy use, the control terminal is not necessary to be installed remote operation software, and the control and controlled terminals use the Hyper Text Transfer Protocol (HTTP protocol) to achieve data exchange. Since the HTTP protocol limits that each connection only handles one request, then, when a server finishes the processing of a customer's request and receives a response from the customer, the connection will be disconnected immediately. In this way, the transmission time can be saved. Since the browser of the control terminal can support the HTTP protocol, then, it is only need to realize a specific Web server program at the controlled terminal. The server program can make appropriate treatment according to the request data sent by the browser of the control terminal, e.g. read the files and return them to the browser of the control terminal, or perform a lock screen operation and return the result to the browser of the control terminal, etc. When the control terminal requests services to the controlled terminal, only the request method and path need to be transmitted. Each method provides a different type of contact between the control terminal and the controlled terminal. In order to make the remote controlled terminal give different feedbacks to different requests of the control terminal, the server program may respond to the HTTP requests received in the manner described below.

When the controlled terminal receives the request, it will perform corresponding operation. The main two operations are accessing the controlled terminal and controlling the controlled terminal. Remote access mainly refers to that can obtain the file system data (folders, files, etc.) of the controlled terminal, and return the same to the browser. Controlling the controlled terminal mainly refers to performing system level operations on the controlled terminal, such as lock the computer, shut down the computer, adjust the volume of the computer system, control the movement of the mouse, quickly open the software, etc. Different operating systems provide different application programming interfaces (e.g. API) and software development kits (e.g. SDK), these APIs and SDKs help developers obtain file data and operate the system of the controlled terminal; for the specific ways, please refer to the development documentation written by the operating system developers.

In order to facilitate the user to access the controlled terminal, a set of user interface may be provided. Since the control terminal uses browser(s), therefore, the set of user interface may be constructed by HTML(5), JavaScript, CSS, etc., and can automatically adapt to different terminal browsers, so as to be easily used.

On the other hand, the browser can be used as a control embedded in the program of the terminal device, there is no difference in essence. That is, the user can not only remotely access and control the controlled terminal via the browser of the control terminal, but can also remotely access and control the controlled terminal by using the browser control embedded in the program of the control terminal.

In short, based on the above-mentioned technical solution, the user uses the browser (or browser control) of the control terminal to remotely access the controlled terminal, and the server program installed in the controlled terminal will return a webpage, which is constructed by HTML(5), JavaScript, CSS, etc., to the control terminal for the user to operate. The user can perform operations by the webpage, and generate a new HTTP request to the server program. The HTTP request carries the user's operation instruction, such as returning a new folder data or locking the computer or returning a video stream, etc., and then the controlled terminal will make corresponding response according to the request data.

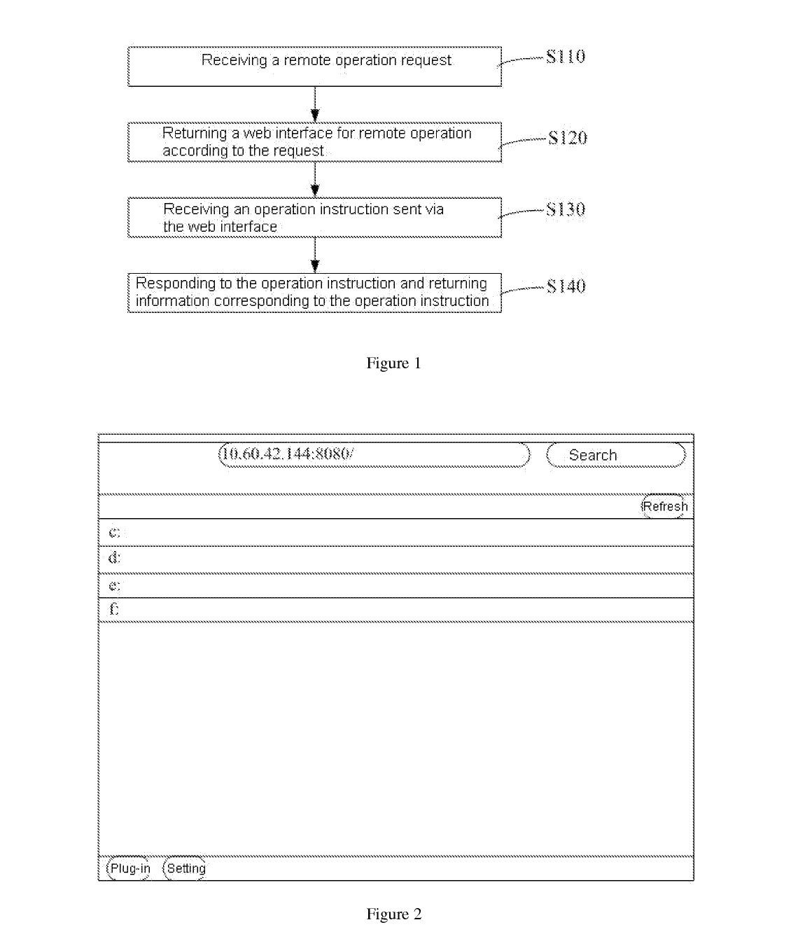

The above-mentioned remote operation method will be described in detail hereinafter; as illustrated in FIG. 1, the remote operation method includes the following steps:

Step S110, receiving a remote operation request. The remote operation request can be an IP address of a controlled terminal, inputted by a user in the address bar of a browser, or a link to be accessed provided by the controlled terminal; and in the case of able to resolve domain names, the request also can be a URL address inputted directly. Hence, the remote operation requests may have various forms. The remote operation request may conform to the Hyper Text Transfer Protocol (HTTP) or the WebSocket Protocol or other protocols. The goal of WebSocket is to achieve a two-way, real-time communication between a browser and a server; the HTTP and the WebSocket do not conflict with each other and can be used simultaneously. The protocol adopted by the remote operation request does not limited to the HTTP or WebSocket, as long as the browser can support it.

Step S120, returning a webpage interface for remote operation according to the request. After receiving the remote operation request, the controlled terminal returns a webpage interface for remote operation. The webpage interface may include an access interface for remotely accessing a file and/or a control interface for remotely controlling a computer. As illustrated in FIG. 2, the access interface for remotely accessing a file partly shows the hard disk partition situation of the controlled terminal, and at the lower left corner of FIG. 2, the control interface for remotely controlling a computer has a plug-in and a setting button for use by the user to control the controlled terminal. In addition to the access interface and the control interface, it may also provide some entertainment interfaces, e.g. web games, etc., and some information interface, e.g. information presentation of the host of the controlled terminal, etc.; moreover, it may further provides some tips interfaces, e.g. webpage interface explaining how to use the remote operation, etc.

Step S130, receiving an operation instruction sent via the webpage interface. The operation instruction may conform to the Hyper Text Transfer Protocol (HTTP), the WebSocket Protocol, etc. For example, if the user uses the mouse to click the “f:” disk in FIG. 2, an operation instruction of HTTP request will be sent to the controlled terminal, and then the controlled terminal will receive the HTTP request operation instruction sent via the webpage interface. Similarly, when the user performs operations on the webpage interface and sends operation instructions like reading a file, shutting down the controlled terminal, locking the controlled terminal, adjusting the volume, adjusting brightness, etc., the controlled terminal can also receive these instructions.

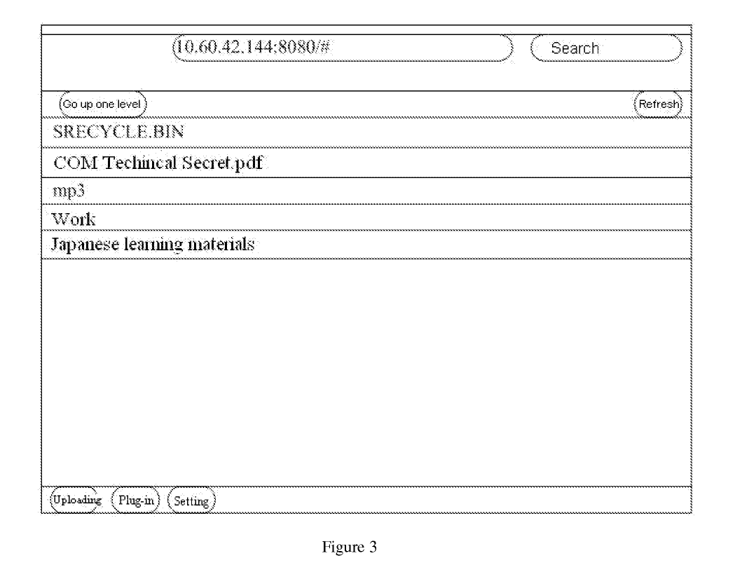

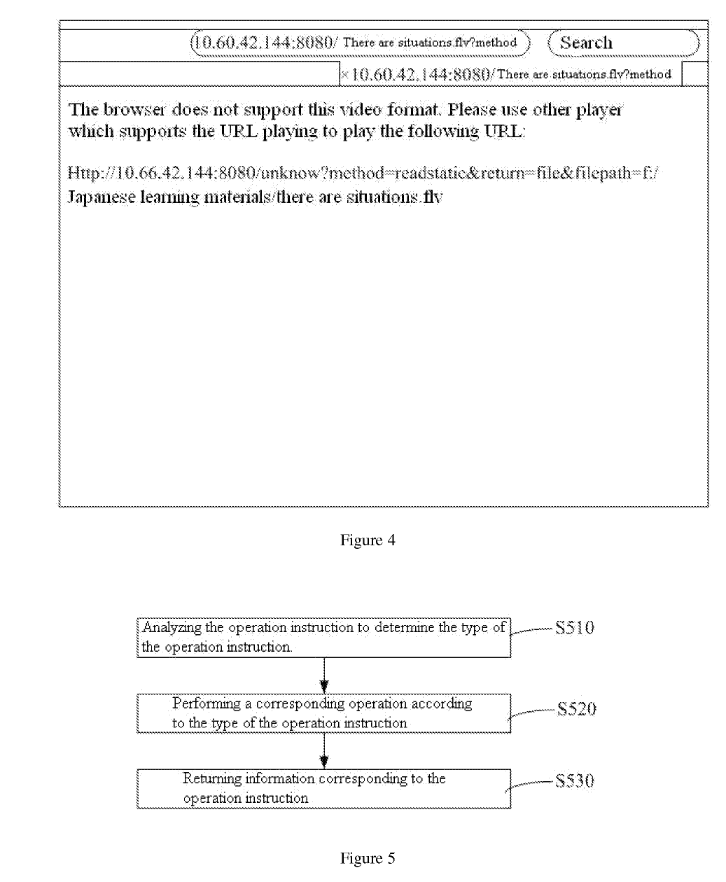

Step S140, responding to the operation instruction and returning information corresponding to the operation instruction. After receiving the operation instruction, the controlled terminal will perform the corresponding operation and return information corresponding to the operation instruction. For example, if the controlled terminal receives an operation instruction that the user used the mouse clicked the “f:” disk in FIG. 2, the controlled terminal will return information about the files, folders, etc. in the “f:” disk directory, and then, after receiving the information, the control terminal will obtain the interface as illustrated in FIG. 3. Similarly, if the operation instructions received by the controlled terminal are like reading a file, shutting down the controlled terminal, locking the controlled terminal, adjusting the volume, adjusting brightness, etc., the controlled terminal will also return information corresponding to these instructions, for example, return content information of a file, or return result information of shutting down, locking, adjusting the volume, adjusting brightness, etc. The control terminal can receive the returned information correspondingly; for instance, after receiving the content information of a file, the control terminal can display the content of the file, e.g. display picture if the file is a picture file, play audio if the file is an audio file, play video if the file is a video file, etc. If the browser itself cannot support the display of file content, an appropriate program can be called to do an embedded display; for instance, when some video formats do not support embedded play, the URL of the file can be provided to the control terminal, and then a player in the control terminal that supports URL play will play the file, as illustrated in FIG. 4. The returned information corresponding to the operation instruction may also conform to the Hyper Text Transfer Protocol or the WebSocket Protocol.

The above-mentioned method transmits the operation instruction through the webpage interface without need of real-time transmission of the computer operation screen; the information amount of the webpage interface is controllable, for example, when accessing the file information in the current directory at the controlled terminal, only the text directory information of the file information needs to be transmitted, and when transmitting control instructions, such as shutdown, lock screen, etc., only these instructions per se need to be transmitted, therefore, the data amount that need to be transmitted can be saved, which reduces not only the demand for network bandwidth, but also the data processing amount by the control and controlled terminals. Moreover, since the control terminal only requires a browser or other tools capable of accessing webpage in order to perform an operation, which can be realized without need of installing specific software on the control terminal, and since the browser and webpage accessing tools are almost equipped in each computer and each mobile phone, therefore, the use convenience is improved.

With the above-mentioned remote operation method, when some users only want to get a file in a remote computer or watch a video in a remote computer or lock a remote computer, the users can access the resources in the computer at the other end of the network and control the computer by a simple, remote way, that is, they may not see the desktop of the controlled terminal.

FIG. 5 is a specific method flowchart illustrating the Step S140 of FIG. 4.

Step S510, analyzing the operation instruction to determine the type of the operation instruction. The types of the operation instructions can be divided into access and control, e.g. browsing files, control instruction, uploading files, etc. Browsing files means browsing files information in various directories of the controlled terminal or obtaining the content of the files. Control instruction means performing a control operation like shut down, lock, adjust the volume, adjust brightness, etc., on the controlled terminal. Uploading files means uploading the files of the control terminal to the controlled terminal. Step S510 analyzing the type of the operation instruction helps to perform different operations for different types in the subsequent steps.

Step S520, performing a corresponding operation according to the type of the operation instruction, which, with combination to Step S530, will be described in detail in following.

Step S530, returning information corresponding to the operation instruction.

When the type of the operation instruction in the step S510 is browsing files, for the step S520 performing a corresponding operation is to read the information about the files in the current directory or a requested file, for the step S530 returning information corresponding to the operation instruction is to return the information about the files in the current directory or the requested file. At the same time of returning the requested file, a MIME type can also be returned, so as to notify the browser which receives the HTTP response that what type the returned file is and how to open it. The MIME type is a type which sets that a file with a certain filename extension is to be opened by an application program, and when a file with the certain filename extension is accessed, the browser will automatically use the specified application program to open the file. When returning information in the step S530, it can also support streaming and broken-point continuingly-transferring functions (e.g. the support for HTTP range). A typical scenario is that, when a mobile phone accesses a URL, it can not only watch a video stored in the computer, but also adjust the video progress. Further, when returning information in the step S530, it can also support the gzip compression standard, so as to make the information transmitted to the browser of the control terminal as little as possible. Certainly, for other contents in the HTTP standard, such as cache, supports can also be provided.

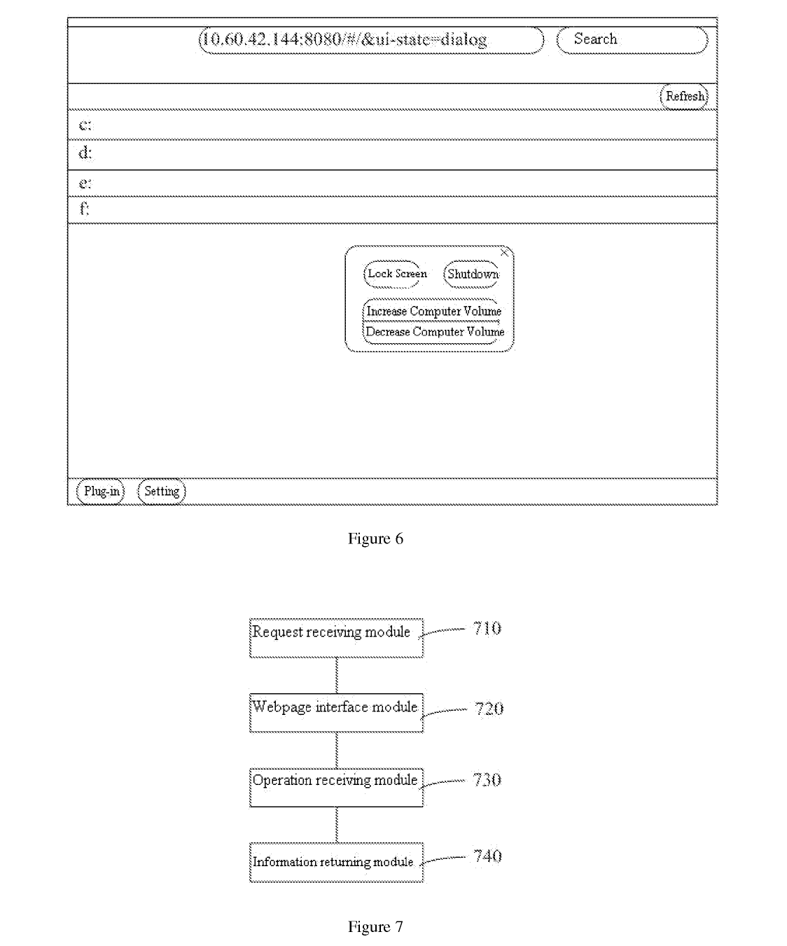

When the type of the operation instruction in the step S510 is control instruction, for the step S520 performing a corresponding operation is to perform the control instruction, for the step S530 returning information corresponding to the operation instruction is to return the result of performing the control instruction. As illustrated in FIG. 6, when a user performs an operation by sending a shutdown control instruction through the webpage interface provided by the step S120, the controlled terminal will receive the instruction and get by the analyzing in the step S510 that the instruction is a shutdown instruction; then the shutdown instruction will be transmitted to the operating system and the operating system will perform the shutdown operation accordingly; finally, the result of the shutdown operation will be returned to the control terminal and through the webpage interface, the control terminal can know whether the shutdown operation is successful.

When the type of the operation instruction in the step S510 is uploading file, for the step S520 performing a corresponding operation is to receive and store the uploaded file, for the step S530 returning information corresponding to the operation instruction is to return the result of receiving and storing the uploaded file. If the user uploads a file, the file will be received and cached or stored through the network, after receiving completely, the result of receiving and storing will be returned to the control terminal, and through the webpage interface, the control terminal can know whether the uploading is successful.

As illustrated in FIG. 7, a remote operation system is provided. The remote operation system includes a request receiving module 710, a webpage interface module 720, an operation receiving module 730 and an information returning module 740.

The request receiving module 710 receives a remote operation request. Here the remote operation request can be an IP address of a controlled terminal, inputted by a user in the address bar of a browser, or a link to be accessed, provided by the controlled terminal; and in the case of able to resolve domain names, the request also can be a URL address inputted directly. Hence, the remote operation requests may have various forms. The remote operation request may conform to the Hyper Text Transfer Protocol (HTTP) or the WebSocket Protocol or other protocols. The goal of WebSocket is to achieve a two-way, real-time communication between a browser and a server; the HTTP and the WebSocket do not conflict with each other and can be used simultaneously. The protocol adopted by the remote operation request does not limited to the HTTP or WebSocket, as long as the browser can support it.

The webpage interface module 720 returns a webpage interface for remote operation according to the request. After receiving the remote operation request, the controlled terminal returns a webpage interface for remote operation. The webpage interface may include an access interface for remotely accessing a file and/or a control interface for remotely controlling a computer. As illustrated in FIG. 2, the access interface for remotely accessing a file partly shows the hard disk partition situation of the controlled terminal, and at the lower left corner of FIG. 2, the control interface for remotely controlling a computer has a plug-in and a setting button for use by the user to control the controlled terminal. In addition to the access interface and the control interface, it may also provides some entertainment interfaces, e.g. web games, etc., and some information interface, e.g. information presentation of the host of the controlled terminal, etc.; moreover, it may further provides some tips interfaces, e.g. webpage interface explaining how to use the remote operation, etc.

The operation receiving module 730 receives an operation instruction sent via the webpage interface. The operation instruction may conform to the Hyper Text Transfer Protocol (HTTP), the WebSocket Protocol, etc. For example, if the user uses the mouse to click the “f:” disk in FIG. 2, an operation instruction of HTTP request will be sent to the controlled terminal, and then the controlled terminal will receive the HTTP request operation instruction sent via the webpage interface. Similarly, when the user performs operations on the webpage interface and sends operation instructions like reading a file, shutting down the controlled terminal, locking the controlled terminal, adjusting the volume, adjusting brightness, etc., the controlled terminal can also receive these instructions.

The information returning module 740 responds to the operation instruction and returns information corresponding to the operation instruction. After receiving the operation instruction, the controlled terminal will perform the corresponding operation and return information corresponding to the operation instruction. For example, if the controlled terminal receives an operation instruction that the user used the mouse clicked the “f:” disk in FIG. 2, the controlled terminal will return information about the files, folders, etc. in the “f:” disk directory, and then, after receiving the information, the control terminal will obtain the interface as illustrated in FIG. 3. Similarly, if the operation instructions received by the controlled terminal are like reading a file, shutting down the controlled terminal, locking the controlled terminal, adjusting the volume, adjusting brightness, etc., the controlled terminal will also return information corresponding to these instructions, for example, return content information of a file, or return result information of shutting down, locking, adjusting the volume, adjusting brightness, etc. The control terminal can receive the returned information correspondingly; for instance, after receiving the content information of a file, the control terminal can display the content of the file, e.g. display picture if the file is a picture file, play audio if the file is an audio file, play video if the file is a video file, etc. If the browser itself cannot support the display of file content, an appropriate program can be called to do an embedded display; for instance, when some video formats do not support embedded play, the URL of the file can be provided to the control terminal, and then a player in the control terminal that supports URL play will play the file, as illustrated in FIG. 4. The information returned by the information returning module 740 may also conform to the Hyper Text Transfer Protocol or the WebSocket Protocol.

The above-mentioned system transmits the operation instruction through the webpage interface without need of real-time transmission of the computer operation screen; the information amount of the webpage interface is controllable, for example, when accessing the file information in the current directory at the controlled terminal, only the text directory information of the file information needs to be transmitted, and when transmitting control instructions, such as shutdown, lock screen, etc., only these instructions per se need to be transmitted, therefore, the data amount that need to be transmitted can be saved, which reduces not only the demand for network bandwidth, but also the data processing amount by the control and controlled terminals. Moreover, since the control terminal only requires a browser or other tools capable of accessing webpage in order to perform an operation, which can be realized without need of installing specific software on the control terminal, and since the browser and webpage accessing tools are almost equipped in each computer and each mobile phone, therefore, user convenience is improved.

With the above-mentioned remote operation system, when some users only want to get a file in a remote computer or watch a video in a remote computer or lock a remote computer, the users can access the resources in the computer at the other end of the network and control the computer by a simple, remote way, that is, they may not see the desktop of the controlled terminal.

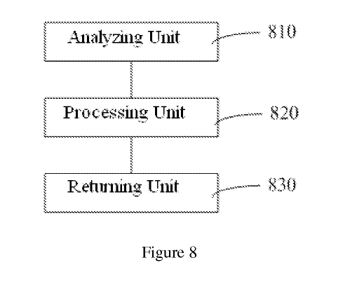

As illustrated in FIG. 8, the above-mentioned information returning module 740 may include an analyzing unit 810, a processing unit 820 and a returning unit 830.

The analyzing unit 810 analyzes the operation instruction to determine the type of the operation instruction. The types of the operation instructions can be divided into access and control, e.g. browsing files, control instruction, uploading files, etc. Browsing files means browsing files information in various directories of the controlled terminal or obtaining the content of the files. Control instruction means performing a control operation like shut down, lock, adjust the volume, adjust brightness, etc., on the controlled terminal. Uploading files means uploading the files of the control terminal to the controlled terminal. The analyzing unit 810 analyzes the type of the operation instruction, which helps to perform different operations for different types in the subsequent steps.

The processing unit 820 performs a corresponding operation according to the type of the operation instruction, which, with combination to the returning unit 830, will be described in detail in following.

The returning unit 830 returns information corresponding to the operation instruction.

When the analyzing unit 810 analyzes that the type of the operation instruction is browsing files, the processing unit 820 will read the information about the files in the current directory or a requested file, and the returning unit 830 will return the information about the files in the current directory or the requested file. At the same time of returning the requested file, a MIME type can also be returned, so as to notify the browser which receives the HTTP response that what type the returned file is and how to open it. The MIME type is a type which sets that a file with a certain filename extension is to be opened by an application program, and when a file with the certain filename extension is accessed, the browser will automatically use the specified application program to open the file. When the returning unit 830 returning information, it can also support streaming and broken-point continuingly-transferring functions (e.g. the support for HTTP range). A typical scenario is that, when a mobile phone accesses a URL, it can not only watch a video stored in the computer, but also adjust the video progress. Further, when the returning unit 830 returning information, it can also support the gzip compression standard, so as to make the information transmitted to the browser of the control terminal as little as possible. Certainly, for other contents in the HTTP standard, such as cache, supports can also be provided.

When the analyzing unit 810 analyzes that the type of the operation instruction is control instruction, the processing unit 820 will perform the control instruction, and the returning unit 830 will return the result of performing the control instruction. As illustrated in FIG. 6, when a user performs an operation by sending a shutdown control instruction through the webpage interface module 720, the controlled terminal will receive the instruction and get by the analyzing unit 810 that the instruction is a shutdown instruction; then the shutdown instruction will be transmitted to the operating system and the operating system will perform the shutdown operation accordingly; finally, the result of the shutdown operation will be returned to the control terminal and through the webpage interface, the control terminal can know whether the shutdown operation is successful.

When the analyzing unit 810 analyzes that the type of the operation instruction is uploading file, the processing unit 820 will receive and store the uploaded file, and the returning unit 830 will return the result of receiving and storing. If the user uploads a file, the file will be received and cached or stored through the network, after receiving completely, the result of receiving and storing will be returned to the control terminal, and through the webpage interface, the control terminal can know whether the uploading is successful.

The foregoing are only preferred embodiments of the present disclosure, and are not used to limit the present disclosure. Any modification, equivalent replacement, or improvement made without departing from the spirit and principle of the disclosure should fall within the scope of the present disclosure. Accordingly, the scope for protection of the present disclosure should be judged according to the attached claims.

1. A remote operation method, comprising:
receiving a remote operation request;
returning a webpage interface for remote operation according to the remote operation request;
receiving an operation instruction sent via the webpage interface; and
responding to the operation instruction and returning information corresponding to the operation instruction.

2. The remote operation method of claim 1, wherein the remote operation request and/or the operation instruction and/or the information conform(s) to the Hyper Text Transfer Protocol or the WebSocket Protocol.

3. The remote operation method of claim 1, wherein the webpage interface comprises an access interface for remotely accessing a file and/or a control interface for remotely controlling a computer.

4. The remote operation method of claim 1, wherein responding to the operation instruction and returning information corresponding to the operation instruction comprises:
analyzing the operation instruction to determine the type of the operation instruction;
performing a corresponding operation according to the type of the operation instruction; and
returning information corresponding to the operation instruction.

5. The remote operation method of claim 4, wherein:
when the type of the operation instruction is browsing files:
performing the corresponding operation comprises reading information about the files in a current directory or a requested file, and
returning information corresponding to the operation instruction comprises returning the information about the files in the current directory or the requested file.

6. The remote operation method of claim 4, wherein:
when the type of the operation instruction is control instruction:
performing the corresponding operation comprises performing the control instruction, and
returning information corresponding to the operation instruction comprises returning a result of performing the control instruction.

7. The remote operation method of claim 4,
wherein when the type of the operation instruction is uploading a file,
wherein performing the corresponding operation comprises receiving and storing a uploaded file, and
wherein returning information corresponding to the operation instruction comprises returning a result of receiving and storing the uploaded file.

8. A remote operation system, comprising:
a request receiving module, configured to receive a remote operation request;
a webpage interface module, configured to return a webpage interface for remote operation according to the remote operation request;
an operation receiving module, configured to receive an operation instruction sent via the webpage interface; and
an information returning module, configured to respond to the operation instruction and return information corresponding to the operation instruction.

9. The remote operation system of claim 8, wherein the remote operation request and/or the operation instruction and/or the information conform(s) to the Hyper Text Transfer Protocol or the WebSocket Protocol.

10. The remote operation system of claim 8, wherein the webpage interface comprises an access interface for remotely accessing a file and/or a control interface for remotely controlling a computer.

11. The remote operation system of claim 8, wherein the information returning module comprises:
an analyzing unit, configured to analyze the operation instruction to determine the type of the operation instruction;
a processing unit, configured to perform a corresponding operation according to the type of the operation instruction; and
a returning unit, configured to return information corresponding to the operation instruction.

12. The remote operation system of claim 11, wherein when the analyzing unit analyzes that the type of the operation instruction is browsing files, the processing unit reads the information about the files in a current directory or a requested file, and the returning unit returns the information about the files in the current directory or the requested file.

13. The remote operation system of claim 11, wherein when the analyzing unit analyzes that the type of the operation instruction is control instruction, the processing unit performs the operation instruction, and the returning unit returns a result of performing the control instruction.

14. The remote operation system of claim 11, wherein when the analyzing unit analyzes that the type of the operation instruction is uploading file, the processing unit receives and stores a uploaded file, and the information returned by the returning unit is the result of receiving and storing the uploaded file.
